(19) United States
(12) Patent Application Publication
(10) Pub. No.: US 2013/0070927 A1
(43) Pub. Date: Mar. 21, 2013

(54) SYSTEM AND METHOD FOR SOUND PROCESSING

(71) Applicant: Aki Sakari Harma, Eindhoven (NL)

(72) Inventor: Aki Sakari Harma, Eindhoven (NL)

(73) Assignee: KONINKLIJKE PHILIPS ELECTRONICS N.V., EINDHOVEN (NL)

(21) Appl. No.: 13/700,467

(22) PCT Filed: May 30, 2011
(86) PCT No.: PCT/IB2011/052356

§ 371 Date: Nov. 28, 2012

(30) Foreign Application Priority Data
Jun. 2, 2010 (EP) 10164679.2

(51) Int. Cl. H04R 5/04

(52) U.S. Cl. CPC H04R 5/04
USPC 381/17

(57) ABSTRACT

A sound processing system receives a stereo signal which, by a segmenter (109) is divided into stereo time-frequency signal segments, each of which may correspond to a frequency domain sample in a given time segment. A decomposer (111) decomposes the time-frequency signal segments by for each pair of stereo time-frequency signal segments performing the steps of: determining a similarity measure indicative of a degree of similarity of the stereo time frequency signal segments; generating a sum time-frequency signal segment as a sum of the stereo time-frequency signal segments; and generating a centre time-frequency signal segment from the sum time-frequency signal segment and a pair of side stereo time-frequency segments from the pair of stereo time-frequency signal segments in response to the similarity measure. A signal generator (113) then generates a multi-channel signal comprising a centre signal generated from the sum time-frequency signal segments and side signals generated from the side stereo time-frequency segments.

### FIELD OF THE INVENTION

The invention relates to a system and method for sound processing and in particular, but not exclusively to upmixing of a stereo signal to a three channel signal.

### BACKGROUND OF THE INVENTION

Conventionally, a large amount of audio content is provided as stereo content. Such stereo content may comprise a variety of signal sources that have very different spatial characteristics. For example, for stereo music content, the desired spatial reproduction of a vocal and background instruments may be very different. Typically the vocalist should be perceived spatially well localized whereas the background instruments may preferably be perceived more diffusely to provide a wide sound image.

In recent years, multi-channel sound reproduction with more than two channels has become increasingly popular and widespread. Accordingly, stereo content may increasingly be reproduced using multi-channel reproduction systems, such as e.g. using surround sound systems.

Accordingly, methods and processes for upmixing a stereo signal to a multi-channel signal with more than two channels have been proposed. An example of such a system is disclosed in US Patent publication US20090198356A1. Systems such as that disclosed in US20090198356A1 seek to divide the signal into a primary signal and an ambient signal by extracting principal signal components from the received signal. Thus, such systems are suitable for identifying dominant signals somewhere in the sound image and following by an extraction of these. This approach tends to not provide an optimum listening experience in all scenarios. For example, it may for some content extract dominant signals that are however not ideally perceived as a spatially well defined sound objects but are rather part of providing a perception of a wide stereo image. Furthermore, the approach may result in signal components that are best suited for being perceived to be spatially well defined may not be so. For example, for a stereo signal comprising a voice source that is not the dominant sound source, the voice signal may be rendered as a more diffused sound whereas a dominant signal source that e.g. is part of an ambient sound environment may be rendered spatially more well defined.

Also, such approaches may often result in some spatial distortions being introduced by the processing resulting in sound sources being spatially shifted or spread. Indeed, the rendering system may be adapted to render dominant or principal signal components at identified locations in the sound image. However, the rendering system may not be ideal for rendering such locations and may therefore result in suboptimal performance.

Thus, upmixing based on such dominant or principal signal analysis may often result in spatial distortions or degradations being introduced. This may e.g. result in the spatial sound image represented by the multi-channel rendering system differing from that originally intended by the creator of the original stereo signal.

Hence, an improved system processing system would be advantageous and in particular a system allowing increased flexibility, reduced complexity, improved spatial perception, improved spatial upmixing and/or improved performance would be advantageous. Specifically, a processing system allowing an upmixing of a stereo signal with improved maintenance of spatial characteristics of the stereo signal would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided sound processing system comprising: a receiver for receiving a stereo signal; a segmenter for dividing the stereo signal into stereo time-frequency signal segments; a decomposer arranged to decompose the stereo time-frequency signal segments by for each pair of stereo time-frequency signal segments: determining a similarity measure indicative of a degree of similarity of the pair of stereo time frequency signal segments; generating a sum time-frequency signal segment as a sum of the pair of stereo time-frequency signal segments; generating a centre time-frequency signal segment from the sum time-frequency signal segment in response to the similarity measure; generating a pair of side stereo time-frequency segments from the pair of stereo time-frequency signal segments in response to the similarity measure; and a signal generator for generating a multi-channel signal comprising a centre signal generated from the centre time-frequency signal segments and side signals generated from the side stereo time-frequency segments.

The invention may allow an improved upmixing of a stereo signal and may in particular allow an improved spatial characteristic of the upmixed signal. In many scenarios the invention may allow an upmixed signal to be generated that has spatial characteristics which more closely correspond to the spatial characteristics of the stereo signal. In particular, locations of sound sources may be closer to those of the stereo signal and intended by the creator of the stereo signal.

The invention may allow an efficient implementation and may automatically adapt to the characteristics of the signal. In particular, the invention may allow a flexible decomposition of a stereo signal into three channels including a centre signal.

The approach may specifically extract sound sources that are centrally placed rather than extract dominant sound sources that may be located in different positions in the sound image. By basing the upmixing on a fixed spatial consideration rather than on an estimation of dominant or principal signal components, an improved spatial consistency is achieved. In particular, the invention may ensure that the upmixed central channel comprises only signal components that are also centrally positioned in the original stereo image.

Each time-frequency signal segment may comprise one (typically complex) sample. Each time-frequency signal segment may correspond to a frequency domain sample in a time segment. The stereo channel may be part of a multi-channel signal such as e.g. a left and right front channel of a surround sound signal. The sound processing apparatus may be arranged to generate an upmix comprising more signals than the centre signal and the side signals. For example, the sound processing apparatus may be arranged to upmix the stereo signal to a surround sound signal comprising e.g. a number of rear or side surround channels in addition to the centre and side channels. The additional channels may be generated in response to the similarity measure or may be independent thereof

In accordance with an optional feature of the invention, the decomposer is arranged to generate the centre time-frequency signal segment by scaling of the sum time-frequency signal segment, the scaling being dependent on the similarity measure.

This may provide improved upmixing in many scenarios. In particular, it may allow improved decomposition. The approach may provide a low complexity yet high quality decomposition and upmixing.

In accordance with an optional feature of the invention, the decomposer is arranged to generate the pair of side stereo time-frequency segments by scaling of the pair of stereo time-frequency signal segments, the scaling being dependent on the similarity measure.

This may provide improved upmixing in many scenarios. In particular, it may allow improved decomposition.

In accordance with an optional feature of the invention, the decomposer is arranged to determine the similarity measure in response to a correlation value for the pair of stereo time-frequency signal segments.

This may provide a particularly suitable similarity measure and may result in improved performance and audio quality of the upmixed signal. The correlation value may be an averaged correlation value with the averaging being over time and/or frequency.

The correlation value may be a value dependent on both an amplitude difference and a phase difference between the pair of stereo time-frequency signal segments.

Specifically, the correlation value may be determined as the real or imaginary component of a complex correlation value, which e.g. may be determined as the multiplication of one segment of the pair of stereo time-frequency signal segments with the complex conjugate of the other segment of the pair of stereo time-frequency signal segments.

Such an approach may in many scenarios provide an improved similarity measure resulting in improved upmixing and audio quality.

In accordance with an optional feature of the invention, the decomposer is arranged to determine the similarity measure in response to the correlation value for the pair of stereo time-frequency signal segments relative to a power measure of at least one of the pair of stereo time-frequency signal segments.

This may provide improved upmixing in many scenarios. In particular, it may allow improved decomposition and/or audio quality. The approach may e.g. provide an increased independence of absolute levels.

In some embodiments a particular advantageous performance can be achieved by determining the similarity measure in response to the correlation value for the pair of stereo time-frequency signal segments relative to power measures of both of the pair of stereo time-frequency signal segments. The power measures may be averaged power measures, e.g. in the time or frequency domain (or both).

In accordance with an optional feature of the invention, the decomposer is arranged to determine the similarity measure in response to a power measure for one of the pair of stereo time-frequency signal segments relative to a power measure for the other one of the pair of stereo time-frequency signal segments.

This may provide an improved upmixing in many scenarios. In particular, it may allow improved decomposition and/or audio quality.

In accordance with an optional feature of the invention, the decomposer is arranged to determine the similarity measure in response to a level difference between the pair of stereo time-frequency signal segments.

This may provide improved upmixing in many scenarios. In particular, it may allow improved decomposition and/or audio quality.

In accordance with an optional feature of the invention, the decomposer is arranged to generate the centre time-frequency signal segment and the pair of side stereo time-frequency segments as a result vector of a matrix multiplication of a vector comprising the pair of stereo time-frequency segments and wherein at least some coefficients of the matrix multiplication depend on the similarity measure.

This may provide high performance while maintaining low complexity.

In accordance with an optional feature of the invention, the sound processing system further comprises a renderer for reproducing the multi-channel signal wherein a rendering of the centre signal is different from a rendering of the side signals.

The invention may allow improved rendering which is adapted to the specific characteristics of different parts of the sound image.

In accordance with an optional feature of the invention, the renderer is arranged to apply stereo widening to the multi-channel signal wherein a degree of stereo widening applied to the centre signal is less than a degree of stereo widening applied to the side signals.

This may provide improved rendering and may in many embodiments provide an improved spatial experience.

In accordance with an optional feature of the invention, the renderer is arranged to apply stereo widening to the multi-channel signal wherein a degree of stereo widening applied to the centre signal is less than a degree of stereo widening applied to the side signals.

This may provide improved rendering and may in many embodiments provide an improved spatial experience.

In accordance with an optional feature of the invention, the receiver is arranged to generate centre time-frequency signal segments only for a frequency interval of the stereo signal, the frequency interval being only a part of a bandwidth of the stereo signal.

This may reduce complexity while maintaining a high audio quality. The frequency interval may for example correspond to a typical audio or voice frequency band. For example, in many embodiments, a lower 3 dB frequency of the interval may be in the interval of [100 Hz; 400 Hz] and a higher 3 dB frequency of the interval may be in the interval of [2 kHz; 6 kHz]

In accordance with an optional feature of the invention, the sound processing system further comprises a voice detector arranged to generate a voice presence estimate for the centre signal; and wherein the decomposer is further arranged to generate the centre signal in response to the voice presence estimate.

This may allow improved performance and an improved audio experience in many embodiments.

According to an aspect of the invention there is provided a method of sound processing system comprising: receiving a stereo signal; dividing the stereo signal into stereo time-frequency signal segments; decomposing the stereo time-frequency signal segments by for each pair of stereo time-frequency signal segments: determining a similarity measure indicative of a degree of similarity of the pair of stereo time frequency signal segments; generating a sum time-frequency signal segment as a sum of the pair of stereo time-frequency signal segments; generating a centre time-frequency signal segment from the sum time-frequency signal segment in response to the similarity measure; generating a pair of side stereo time-frequency segments from the pair of stereo time-frequency signal segments in response to the similarity measure; and generating a multi-channel signal comprising a centre signal generated from the centre time-frequency signal segments and side signals generated from the side stereo time-frequency segments.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a sound reproduction system in accordance with some embodiments of the invention;

FIG. 2 illustrates an example of a histogram of sound source positions for a sample of music files;

FIG. 3 illustrates an example of a signal decomposer for a sound reproduction system in accordance with some embodiments of the invention; and

FIG. 4 illustrates an example of a sound reproduction system in accordance with some embodiments of the invention;

### DETAILED DESCRIPTION OF SOME EMBODIMENTS OF THE INVENTION

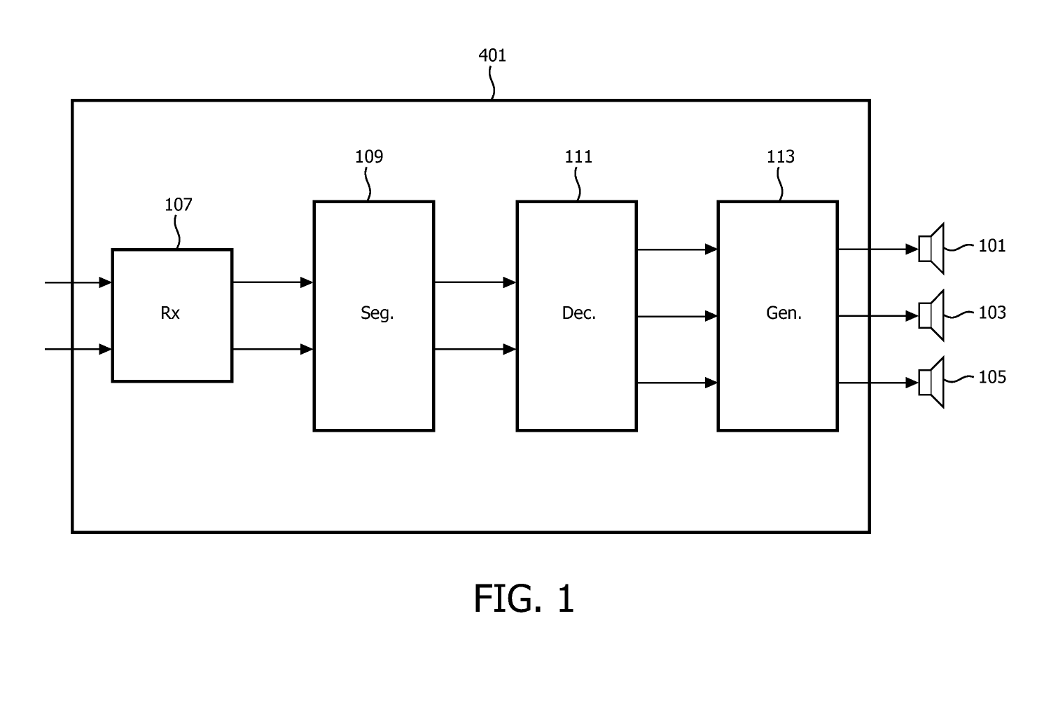

FIG. 1 illustrates an example of a sound reproduction system in accordance with some embodiments of the invention. The sound reproduction system receives a stereo signal and upmixes this to a three channel signal which is then rendered from three different speakers 101, 103, 105.

The upmixing approach may in many scenarios allow improved quality as it may allow the rendering of signal components to be adapted to the specific characteristics of these. For example, a central speaker may be extracted and rendered from a centrally positioned speaker 103 whereas ambient signal components are rendered from speakers 101, 105 positioned to the front-side of the listening position.

In the example of FIG. 1, the upmixing is performed by decomposing the stereo signal into a central signal and a stereo signal. The decomposition is based on time-frequency signal segments and for each stereo pair of segments, a similarity measure is used to estimate how centrally placed the corresponding signal component is in the stereo sound image. A time-frequency signal segment corresponds to a representation of the signal in a given time interval and frequency interval. Typically, a time-frequency signal segment will correspond to a (complex) frequency sample generated for a given time segment. Thus, each time-frequency signal segment may be a FFT bin value generated by applying an FFT to the corresponding segment. In the following the term time-frequency tile will be used to refer to a time-interval and frequency interval combination, i.e. to a position in the time-frequency domain. Thus, the term tile refers to the position whereas the term signal segment refers to the signal value(s).

The generated pair of stereo signal segments is then distributed to a center channel and side channels in dependence on the similarity measure. The approach does not estimate positions of dominant signal components or perform a separation into a primary and residual (or ambient) signals but rather extracts the centrally located sound source depending on the dominance of the centrally located sound source for the specific time-frequency tile of the segment.

Thus, the system of FIG. 1 uses a signal processing method where the stereo content is decomposed into three new signals with one signal mainly containing the dominating central source, such as e.g. typically the singer in music, and the two other signals correspond to a (possibly enhanced) stereo signal that does not contain the dominant central source or where the level of that source is significantly attenuated. The central source signal may then be reproduced/rendered using a suitable method which can provide a clear well positioned central image whereas a more diffuse and less central rendering is used for the other signals. In particular, a spatial widening algorithm may be applied to the resulting stereo signal.

The system seeks to separate the sound source placed in or very near the centre from the signal as a whole. Furthermore, the separation is a dynamic adaptive separation which is automatically adjusted to reflect the characteristics of the signal and in particular to reflect whether such a dominant signal is indeed present at the central spatial position.

One of the advantages of using a central extraction rather than a separation into primary/dominant and residual signals is that it allows the system to maintain the spatial organisation and arrangement of the original stereo signal.

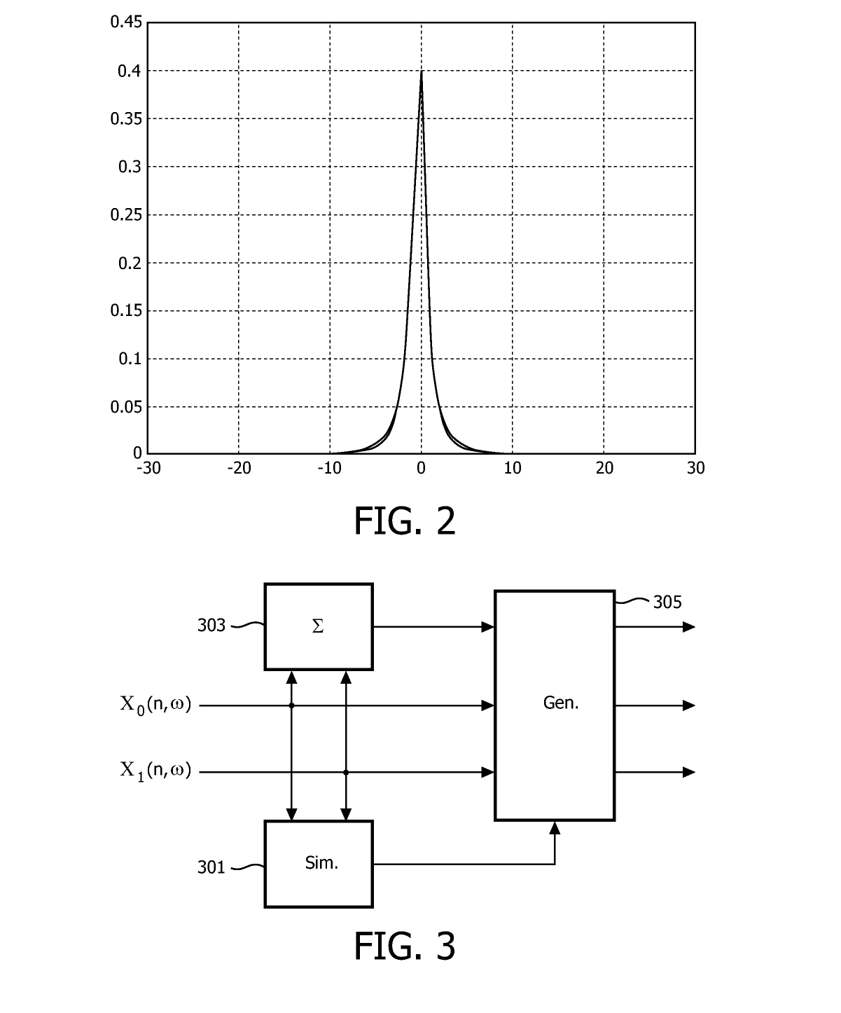

Furthermore, for many practical applications, it is a reasonable assumption that dominant sources are placed centrally. Indeed, for large majority of music recordings there is a dominating source panned exactly to the centre position. For example, FIG. 2 illustrates an example of a histogram of panning directions for the central vocal spectrum region in approximately 1400 songs from different musical genres. As illustrated, the dominating content is typically panned to the centre of the spatial image.

The sound reproduction system of FIG. 1 comprises a receiver 107 which receives a stereo signal. The stereo signal may be received from any suitable internal or external source and may be part of a multi-channel signal such as a surround sound signal. For example, the stereo signal may be the front side channels of a surround sound signal.

The receiver 107 is coupled to a segmenter 109 which proceeds to divide the stereo signal into stereo time-frequency signal segments. In particular, each of the two stereo signals is divided into signal samples corresponding to a specific frequency interval in a specific time interval.

In more detail, the incoming stereo signals are divided into time segments and the signal in each time segment is transformed into the frequency domain to generate the time-frequency segments.

Specifically, the two stereo signals are segmented into time segments by applying a window function in overlapping short-time segments, e.g. using a Hanning window function. In each time segment, the Fast Fourier Transform (FFT) is then applied to generate the frequency domain representation of the segment. Thus, time-frequency signal segments are obtained and specifically each time-frequency signal segment comprises one sample (for each channel i.e. a stereo time-frequency signal segment will comprise one sample for each channel). The generated time-frequency signal segments may be represented by the spectrum vectors X₀(n, ω) and X₁(n, ω) corresponding to the two input signals of windowed segment n and frequency variable ω. For convenience of notation we move to matrix representation where

[X(m,ω)]=[X₀(m,ω), X₁(m,ω)]

Thus, the segmenter 109 divides the input stereo signal into stereo time-frequency signal segments. These stereo time-frequency signal segments are then fed to a decomposer 111 coupled to the segmenter 109.

The decomposer 111 is arranged to decompose an input stereo time-frequency signal segment into a centre time-frequency signal segment and two side stereo time-frequency segments. Specifically, for each pair of stereo samples (corresponding to a stereo time-frequency segment), the decomposer 111 generates one sample that corresponds to a centrally located sound source as well as a pair of samples corresponding to a resulting stereo signal after compensation for the extraction of the central source.

The centre time-frequency signal segment is specifically generated from a sum of the time-frequency signal segments for the two channels of the stereo signal and thus represents the signal component that is common in the two channels corresponding to the spatial central position. The decomposer 111 thus does not decompose the stereo signal into a primary or dominant signal and an ambient signal but rather decomposes the stereo signal into a centre signal component and a side component.

The decomposer 111 is coupled to a signal generator 113 which receives the sum time-frequency signal segments and combines these into a centre signal. In addition, the signal generator 113 receives the side stereo time-frequency segments and combines these into two side signals. The centre signal and the two side signals may then be fed to the centre speaker 103, and the two side speakers 101, 105 respectively. The signal generator 113 may specifically collate the appropriate time-frequency segments in each time segment and perform an inverse FFT as will be known to the skilled person.

The approach thus decomposes the input stereo signal into a signal corresponding to the centre position in the sound image of the input signal and two side signals corresponding to the side positions. The decomposition is performed in time-frequency tiles where the distribution of the input stereo signal to the different channels is for each time-frequency tile dependent on a similarity measure for the input stereo channels in the time-frequency tile.

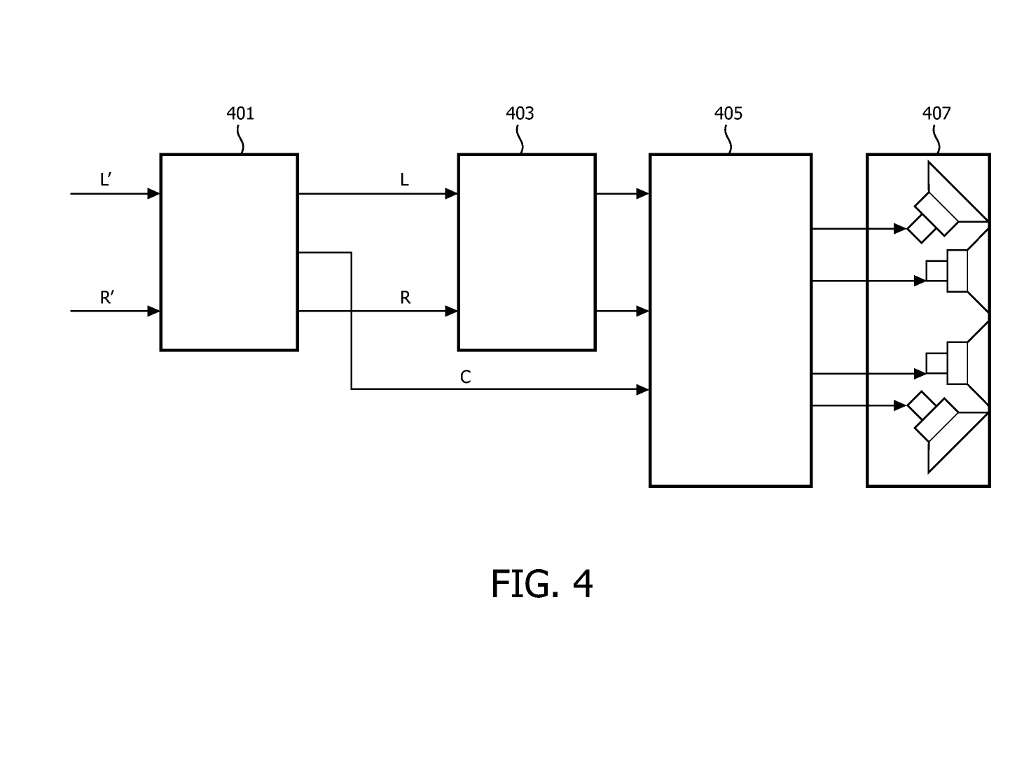

FIG. 3 illustrates the decomposer 111 of FIG. 1 in more detail. The pairs of stereo time-frequency signal segments X₀(n,ω) and X₁(n,ω) are fed to a similarity processor 301 which is arranged to generate a similarity measure for each pair of time-frequency signal segments. The similarity measure is indicative of a degree of similarity between the time-frequency tiles of the pair of time-frequency signal segments, i.e. of how close the signal is in that time and frequency interval. The similarity measure may be an averaged similarity measure e.g. by the measure itself being averaged over time and/or frequency or by one or more values used in calculating the measure being averaged over time and/or frequency. Thus, the similarity for one time-frequency tile may be determined from an averaging over a plurality of time-frequency tiles in the time and/or frequency domain.

The pairs of stereo time-frequency signal segments X₀(n,ω) and X₁(n,ω) are furthermore fed to a sum processor 303 which is arranged to generate a sum time-frequency signal segment as a sum of the stereo time-frequency signal segments. Thus, for each time-frequency tile, a sum time-frequency signal segment is generated by adding the two segments of the pair of stereo time-frequency signal segments of that time-frequency tile. As the sum segment is generated as a fixed non-weighted summation, it represents the central position in the spatial segment and thus the sum signal may be seen as the contribution of the time-frequency tile to the sound source in the centre of the image.

The pairs of stereo time-frequency signal segments X₀(n,ω) and X₁(n,ω) are furthermore fed to an upmix processor 305 which is furthermore coupled to the sum processor 303 and the similarity processor 301. The upmix processor 305 is arranged to generate three output time-frequency segments from the two input time-frequency signal segments X₀(n,ω) and X₁(n,ω) and the sum time-frequency signal segment. Specifically, a centre time-frequency signal segment is generated from the sum time-frequency signal segment in response to the similarity measure. In particular, the higher the similarity measure the higher the sum signal is weighted, and thus the higher the amplitude of the resulting centre time-frequency signal segment. Similarly, a pair of side stereo time-frequency segments is generated from the pair of stereo time-frequency signal segments in response to the similarity measure. In particular, the lower the similarity measure the higher the stereo time-frequency segment is weighted and thus the higher the amplitude of the resulting side time-frequency signal segment. Thus, the upmixer 205 is arranged to generate a first side time-frequency signal segment from a first of the stereo time-frequency signal segments by weighting this dependent on the similarity measure, to generate a second side time-frequency signal segment from a second of the stereo time-frequency signal segments by weighting this dependent on the similarity measure, and to generate a centre time-frequency signal segment from the sum time-frequency signal segment by weighting this dependent on the similarity measure.

In the example, the weighting of the signal segments is performed by a low complexity scaling of these, where the scaling value depends on the similarity measure. In the example, the decomposer 111 is specifically arranged to generate the centre time-frequency signal segment and the pair of side stereo time-frequency segments as a result vector of a matrix multiplication of a vector comprising the pair of stereo time-frequency segments with the coefficients of the matrix multiplication depending on the similarity measure. Furthermore, the generation of the sum signal is implemented as a part of this matrix operation (e.g. the sum processor 303 and upmix processor 305 of FIG. 2 may be seen to be combined). Thus, the decomposer 111 may implement a mapping of the two input time-frequency signal segments

[X(m,ω)]=[X₀(m,ω), X₁(m,ω)]

to an output vector Y(n,ω) comprising three time-frequency signal segments, namely the centre time-frequency signal segment and the two side time-frequency signal segments according to the matrix operation:

Y(n,ω)=G(n,ω)X(n,ω)

where the upmixing matrix G(n,ω) is given by

$$G ( n , ω ) = [ \begin{matrix}1 - g ( n , ω ) & 0 \\ 0 & 1 - g ( n , ω ) \\ g ( n , ω ) / 2 & g ( n , ω ) / 2\end{matrix} ]$$

with g(n,ω) representing the similarity measure with a range of [0,1] wherein 1 is indicative of the input pair of stereo time-frequency signal segments being identical and 0 is indicative of the input pair of stereo time-frequency signal segments being substantially different, independent or uncorrelated.

Thus, when the value of the similarity measure is close to one, the signal represented at frequency index ω, i.e. the input pair of stereo time-frequency signal segments, is routed to the centre signal as a sum signal and if it is close to zero the two stereo signals are routed directly to the two side output signals.

Thus, the system of FIG. 1 extracts a signal component at the centre spatial location from the sound image and generates this as a separate channel which can then be reproduced independently. In addition, side channels are generated with this central position signal source removed (or at least attenuated). The decomposition is furthermore adapted such that it in each time-frequency tile depends on the dominance of the central spatial position relative to other positions. As a result, the extracted central signal is not merely the sound signal that is located centrally but is rather a specific significant sound source located at the central position. Thus, the approach may result in a single central sound source being extracted while allowing lower level background sound sources located in the centre to remain in the side channels. For example, the system may allow a central voice to be extracted while allowing e.g. high or low frequency background noise to remain in the side channels to be processed together with non-central background noise.

The approach of extracting central sound sources rather than just dominant or principal sound sources ensures that the spatial characteristics of the generated central signal are accurately known and thus can be reproduced accurately. Specifically, the centre signal can be reproduced directly in the centre e.g. by a separate speaker. Thus, the system does not introduce spatial variations and may more accurately reproduce the creators intended sound image from a (more than 2) multi-channel reproduction system.

The approach provides highly advantageous results for stereo content that has important sound sources centrally located. In particular, for stereo content wherein a perceptually dominating sound (e.g., a leading singer in music) is panned exactly to the centre of the spatial image, a particular advantageous sound reproduction has been found to be achieved. However, as indicated by FIG. 2, such situations frequently occur in practice.

Different similarity measures may be used in different embodiments. For example, in some embodiments, the similarity measure may be generated as an indication of, or comprise a contribution from, a power measure for one of the pair of stereo time-frequency signal segments relative to a power measure for the other one of the pair of stereo time-frequency signal segments and/or a level difference value for the pair of stereo time-frequency signal segments.

For example; the energy ratio:

$${E}_{r} ( n , ω ) = \frac{{E}_{2} ( n , ω )}{{E}_{1} ( n , ω )}$$

where Eₙ, denotes an energy or power of channel n of the input stereo signal may be used.

As a more practical example, a similarity value may be generated from:

$${g}^{′} ( n , ω ) = \frac{\vert {E}_{2} ( n , ω ) - {E}_{1} ( n , ω ) \vert}{\sqrt{{E}_{1} ( n , ω ) {E}_{2} ( n , ω )}}$$

Typically, the similarity value is determined taking into consideration a plurality of time-frequency tiles. Thus, the similarity value may be an averaged value, either by a direct averaging of the similarity value or by an averaging of one or more values used to calculate the similarity value. The averaging may be over a sequence of time values n, frequency indices ω or both of these.

In the following a particularly advantageous similarity value will be described which is based on a correlation value for the pair of stereo time-frequency signal segments. In the specific example, a measure is generated which relates the correlation value relative to a power measure of at least one segment of the pair of stereo time-frequency signal segments. Indeed, the similarity measure is generated to comprise a contribution from a ratio between the correlation value and a power measure of one segment of the pair of stereo time-frequency signal segments, as well as a contribution from a ratio between the correlation value and a power measure for both segments of the pair of stereo time-frequency signal segments. The two contributions may provide different relations between level differences and the similarity value and the relative weighting of each may be dependent on the specific characteristics of the individual embodiment.

More specifically, the cross-correlation between the two stereo signals at frequency index ω is given by

C(ω)=<X₁(n,ω)X*₂(n,ω)>

where < > is the expectation and the asterisk * denotes complex conjugation.

In the specific embodiments, the expectation value is generated by averaging the correlation value over a time window by use of a sliding integrator. In particular, a first-order integrator may be used:

C(n,ω)=γC(n−1,ω)+(1−γ)X₁(n,ω)X*₂(n,ω)

where the integration parameter Y is a value that is typically selected to be close to one (e.g, 0.8).

Secondly, the expectation of the power/energy of the signal at frequency w of channel M of the input stereo signal is given by

E_{M}(ω)=<X_{M}(n,ω)X*_{M}(n,ω)>

This can also be computed using a sliding integrator such that

E_{M}(n,ω)=γE_{M}(n−1,ω)+(1−γ)X_{M}(n,ω)X*_{M}(n,ω).

A similarity value may be generated by determining a value that is required to scale one signal in order to be identical to the other signal. In this case, the gain coefficient can be obtained by minimizing the following cost function

Q= [symbol] X₁−b·X₂|²

[symbol]

The minimization of Q yields:

$$b = \frac{< {X}_{1} {X}_{2}^{*} >}{< {X}_{2} {X}_{2}^{*} >} = \frac{C ( n , ω )}{{E}_{2} ( n , ω )}$$

The level difference b is practical to express in the logarithmic form. Therefore the complex-valued correlation term may typically be replaced by its absolute value or the absolute value of the real-part of the term.

This leads to a similarity value given by:

$$K = log ( \frac{Abs [ C ( n , ω ) ]}{{E}_{M} ( n , ω )} )$$

where M represents one of the input stereo channels (i.e. M=1 or 2). In some embodiments, this value may be determined for both channels, i.e. both for M=1 and M=2.

Using the real value of the correlation rather than the correlation itself or the absolute value of the correlation ensures that the correlation value also reflects the phase difference between the time-frequency signal segments.

In some cases, a similarity value may be generated which relates the correlation value to the energy of both stereo signals. For example, a similarity value may be generated as:

$$A = a cos ( \frac{Re [ C ( n , ω ) ]}{\sqrt{{E}_{1} ( n , ω ) {E}_{2} ( n , ω )}} )$$

The similarity measure may be generated from one or more of these similarity values.

Specifically, the following similarity value may be calculated:

$$S ( n , ω ) = exp [ - ( {( \frac{K}{μ} )}^{2} + \frac{{( \frac{π A}{2 δ} )}^{2}}{2} ) ]$$

where the parameters μ and θ can be used to control the performance of the decomposition by weighting the different similarity value contributions to provided the desired performance. Typically suitable values for typical stereo audio material may around μ=θ=0.4. Note that the use of the bivariate Gaussian function is here an example of a function which yields a maximum value (one) with a certain combination or combinations of the two measures and a smaller value (≧0) for all other combinations of the values. It will be appreciated that many alternative functions exist that the same properties and that any such function may for example be used.

The calculated similarity value S(n,ω) is close to one when the signals are similar and close to zero when they are dissimilar. Therefore, in some embodiments, this value may directly be used as the similarity measure:

g(n,ω)=S(n,ω)

In some embodiments, there may be additional temporal smoothing of the parameter value using, e.g., a leaky integrator similar to the one used above for E_{M}(ω).

The approach thus generates three upmixed signals from an input stereo signal. The three output signals may then be rendered and specifically a different rendering may be applied to the centre signal than to the side signals.

For example, the centre signal may be rendered by different speakers as e.g. in the example of FIG. 1. Alternatively or additionally, different signal processing may be applied to the centre signal than for the side signals. In particular, a stereo widening may be applied to the side signals but not to the centre signal. This may result in a sound image being rendered with an enhanced widened sound image while at the same time maintaining the perception of a spatially well defined sound source in the centre.

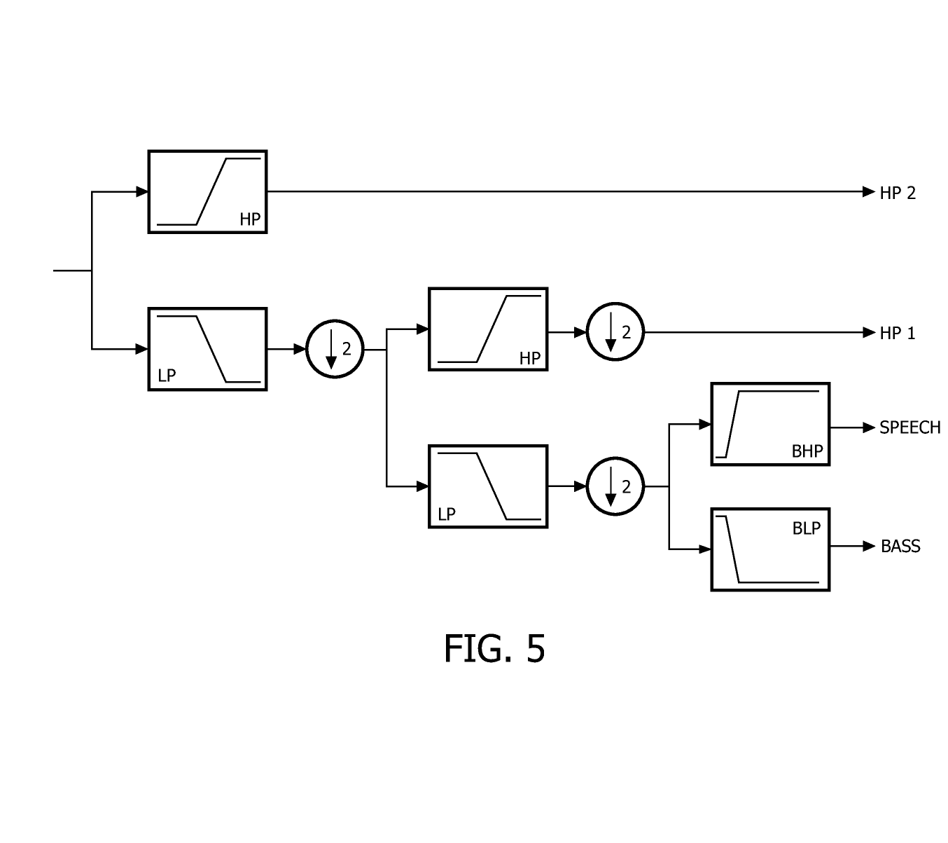

FIG. 4 illustrates an example of a sound processing or reproduction system wherein a different subset of the available speakers is used for the centre signal than for any of the side signals. In addition, the system applies stereo widening to the upmixed side signals but not to the centre signal.

FIG. 4 illustrates an upmixer 401 which implements the signal processing described with reference to FIG. 1, and thus generates a centre signal C and two side signals L,R. The side signals L,R are fed to a stereo widener 403 which performs a stereo widening. It will be appreciated that any suitable stereo widening may be applied and that various algorithms will be known to the skilled person. The stereo widened signal is fed to a reproduction mixer 405 which also receives the centre signal. The reproduction mixer 405 is coupled to a set of speakers 407 which in the example includes four speakers. The reproduction mixer 405 reproduces the input signal using a different subset of speakers for each signal. Specifically, the left side signal and right side signals are reproduced by only the left and right speaker respectively, whereas the centre channel is reproduced by all speakers.

It will be appreciated that in some embodiments, the centre signal may also experience some spatial widening (e.g. with one of the side signals). However, the degree of widening may in such scenarios be less when involving the centre signal than when only involving the side signals.

In some embodiments, the described upmixing may only be applied to a frequency interval of the input stereo signal. For example, the generation of the centre signal may only be performed in a frequency interval, such as e.g. only for an audio band, such as from 200 Hz to 5 kHz. Thus, in such embodiments, the stereo centre time-frequency signal segments may only be generated by the described process in a limited frequency interval, and accordingly the resulting centre signal may be restricted to a limited frequency interval. However, in many embodiments, the centre sound source may be limited in the frequency domain and therefore this approach may only introduce limited degradation while achieving a substantial reduction in required computational resource.

For example, for a voice processing system, the computational complexity of the voice processing can be significantly reduced if it is only applied at the frequency band where the spectrum energy of human voice is mainly concentrated. This region is approximately from 150 Hz to 5 kHz. In some embodiments, frequency-specific processing is performed by decomposing the input signal to three or more subbands which are then down-sampled to the nominal rate corresponding to the bandwidth of the band. Such a subband decomposition may e.g. be based on a Quadrature Mirror

Filter architecture such as that illustrated in FIG. 5. The set of analysis filters splits the signal into three subbands. Correspondingly, after the processing, a synthesis filterbank can be used to reconstruct the signal.

In some voice processing embodiments, the system may further comprise a voice detector which generates a voice presence estimate for the centre signal. This voice presence estimate may be indicative of the likelihood that the generated centre signal corresponds to a voice signal. It will be appreciated that any suitable algorithm for generating a voice presence (or activity) estimate may be used without detracting from the invention and that the skilled person will be aware of many suitable algorithms.

In such embodiments, the system may then be arranged to generate the centre signal in response to the voice presence estimate. This may e.g. be done by making the generation of the time-frequency signal segment from the sum time-frequency signal segment dependent on the voice presence estimate. For example, if the voice presence estimate indicates that the currently extracted centre signal does not contain voice (or is unlikely to) it may reduce the value g(n,ω) such that the more of the signal remains in the side signals corresponding to the original stereo signal.

As an example, in some embodiments a voice detection algorithm may be used to analyze the content in the separated voice center channel and the gains can be controlled such that the center channel is separated only if the extracted signal contains human voice

It will be appreciated that the above description for clarity has described embodiments of the invention with reference to different functional circuits, units and processors. However, it will be apparent that any suitable distribution of functionality between different functional circuits, units or processors may be used without detracting from the invention. For example, functionality illustrated to be performed by separate processors or controllers may be performed by the same processor or controllers. Hence, references to specific functional units or circuits are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, circuits or method steps may be implemented by e.g. a single circuit, unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. A sound processing system comprising:
a receiver for receiving a two-channel stereo signal;
a segmenter for dividing the two-channel stereo signal into stereo time-frequency signal segments;
a decomposer arranged to decompose the stereo time-frequency signal segments by for each pair of stereo time-frequency signal segments:
determining a similarity measure indicative of a degree of similarity of the pair of stereo time frequency signal segments,
generating a sum time-frequency signal segment as a sum of the pair of stereo time-frequency signal segments,
generating a centre time-frequency signal segment from the sum time-frequency signal segment in response to the similarity measure, and
generating a pair of side stereo time-frequency segments from the pair of stereo time-frequency signal segments in response to the similarity measure; and
a signal generator for generating a multi-channel signal comprising a centre signal generated from the centre time-frequency signal segments and side signals generated from the side stereo time-frequency segments;
a stereo widener for applying stereo widening to the multi-channel signal wherein a degree of stereo widening applied to the centre signal is less than a degree of stereo widening applied to the side signals.

2. The sound processing system of claim 1 wherein the decomposer is arranged to generate the centre time-frequency signal segment by scaling of the sum time-frequency signal segment, the scaling being dependent on the similarity measure.

3. The sound processing system of claim 1 wherein the decomposer is arranged to generate the pair of side stereo time-frequency segments by scaling of the pair of stereo time-frequency signal segments, the scaling being dependent on the similarity measure.

4. The sound processing system of claim 1 wherein the decomposer is arranged to determine the similarity measure in response to a correlation value for the pair of stereo time-frequency signal segments.

5. The sound processing system of claim 4 wherein the correlation value is a value dependent on both an amplitude difference and a phase difference of the pair of stereo time-frequency signal segments.

6. The sound processing system of claim 4 wherein the decomposer is arranged to determine the similarity measure in response to the correlation value for the pair of stereo time-frequency signal segments relative to a power measure of at least one of the pair of stereo time-frequency signal segments.

7. The sound processing system of claim 4 wherein the decomposer is arranged to determine the similarity measure in response to a power measure for one of the pair of stereo time-frequency signal segments relative to a power measure for the other one of the pair of stereo time-frequency signal segments.

8. The sound processing system of claim 1 wherein the decomposer is arranged to determine the similarity measure in response to a level difference between the pair of stereo time-frequency signal segments.

9. The sound processing system of claim 1 wherein the decomposer is arranged to generate the centre time-frequency signal segment and the pair of side stereo time-frequency segments as a result vector of a matrix multiplication of a vector comprising the pair of stereo time-frequency segments and wherein at least some coefficients of the matrix multiplication depend on the similarity measure.

10. The sound processing system of claim 1 further comprising a renderer for reproducing the multi-channel signal wherein a rendering of the centre signal is different from a rendering of the side signals.

11. (canceled)

12. The sound processing system of claim 10 wherein the renderer is arranged to render the multi-channel signal using a set of speakers; and a subset of the set of speakers used to render the centre signal is different than a subset of the set of speakers used to render the side signals.

13. The sound processing system of claim 1 wherein the receiver is arranged to generate centre time-frequency signal segments only for a frequency interval of the two-channel stereo signal, the frequency interval being only a part of a bandwidth of the two-channel channel stereo signal.

14. The sound processing system of claim 1 further comprising a voice detector arranged to generate a voice presence estimate for the centre signal; and wherein the decomposer is further arranged to generate the centre signal in response to the voice presence estimate.

15. A method of sound processing system comprising:
receiving a two-channel stereo signal;
dividing the two-channel stereo signal into pairs of stereo time-frequency signal segments;
decomposing the stereo time-frequency signal segments by, for each pair of stereo time-frequency signal segments:
determining a similarity measure indicative of a degree of similarity of the pair of stereo time frequency signal segments,
generating a sum time-frequency signal segment as a sum of the pair of stereo time-frequency signal segments,
generating a centre time-frequency signal segment from the sum time-frequency signal segment in response to the similarity measure, and
generating a pair of side stereo time-frequency segments from the pair of stereo time-frequency signal segments in response to the similarity measure; and
generating a multi-channel signal comprising a centre signal generated from the centre time-frequency signal segments and side signals generated from the side stereo time-frequency segments;
applying stereo widening to the multi-channel signal wherein a degree of stereo widening applied to the centre signal is less than a degree of stereo widening applied to the side signals.
